(19) United States
(12) Patent Application Publication
(10) Pub. No.: US 2020/0090034 A1
(43) Pub. Date: Mar. 19, 2020

(54) Determining Intent from Unstructured Input to Update Heterogeneous Data Stores

(71) Applicant: salesforce.com, inc., San Francisco, CA (US)

(72) Inventors: Govardana Sachithanandam RAMACHANDRAN, San Francisco, CA (US); Shashank HARINATH, San Francisco, CA (US); Abhishek SHARMA, San Francisco, CA (US); Jean-Marc SOUMET, San Jose, CA (US); Michael MACHADO, San Francisco, CA (US); Bryan MCCANN, San Francisco, CA (US)

(21) Appl. No.: 16/134,959

(22) Filed: Sep. 18, 2018

(51) Int. Cl. G06N 3/08; G10L 15/16; G10L 15/06; G06F 17/30

(52) U.S. Cl. CPC G06N 3/08; G10L 15/16; G06F 17/30684; G06F 17/30002; G06F 17/3069; G10L 15/063

(57) ABSTRACT

For a database system accessible by one or more users, a neural network model and related method are provided that allow a user of the database system to provide unstructured input in the form of a verbal or textual narrative or utterance that expresses the information in a language and manner that is more comfortable for the user. A portion of the narrative or utterance may relate to one or action items that the user intends to be taken with respect to the database system, such as creating, updating, modifying, or deleting a database item (e.g., contact, calendar item, deal, etc.). The neural model processes the unstructured input (narrative or utterance) and determines or classifies the intent with respect to the action item for the database.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to database systems, and more specifically to systems and methods for determining intent from unstructured input to update heterogeneous data stores.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Computer and software development is evolving away from the client-server model toward network-based processing systems that provide access to data and services via the Internet or other networks. In contrast to traditional systems that host networked applications on dedicated server hardware, a “cloud” computing model allows applications to be provided over the network “as a service” supplied by an infrastructure provider. The infrastructure provider typically abstracts the underlying hardware and other resources used to deliver a user-developed application so that a user (e.g., consumer of cloud-based services) no longer needs to operate and support dedicated server hardware. The cloud computing model can often provide substantial cost savings to the user over the life of the application because the user no longer needs to provide dedicated network infrastructure, electrical and temperature controls, physical security and other logistics in support of dedicated server hardware.

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.). In one example, the cloud platform may support customer relationship management (CRM) solutions. This may include support for sales, service, marketing, community, analytics, applications, and the Internet of Things (IoT).

It is not uncommon for a multi-tenant database system to store data for different tenants according to tenant-specific schemas and/or data arrangements. This creates a database that encompasses multiple data stores that are heterogeneous because each of the data stores store different information according to the different schemas and/or data arrangements. This presents a challenge to both users and developers as the users are often constrained to enter new data and/or specify data changes using a structured approach built around a user interface that is typically constrained by the schema of the underlying data store.

### BRIEF DESCRIPTION OF THE DRAWINGS

FIG. 1 illustrates a block diagram of an example environment wherein systems and methods for predicting entities for database query results may be used according to some embodiments.

FIG. 2 illustrates a block diagram of another example environment according to some embodiments.

FIG. 3 is a simplified diagram of a computing device according to some embodiments.

FIG. 4 is a diagram of a neural network according to some embodiments.

FIG. 5 is a diagram of a neural network according to some embodiments.

FIG. 6 is a diagram of a portion of a pre-processing layer of a neural network according to some embodiments.

FIG. 7 is a simplified diagram of an example of unstructured natural language input according to some embodiments.

FIG. 8 illustrates a decision flow for presenting a user with a determination or classification of intent based on confidence level according to some embodiments.

FIG. 9 is a flowchart of a method for configuring or setting the training of a neural network according to some embodiments.

In the figures, elements having the same designations have the same or similar functions.

### DETAILED DESCRIPTION

This description and the accompanying drawings that illustrate aspects, embodiments, implementations, or applications should not be taken as limiting—the claims define the protected invention. Various mechanical, compositional, structural, electrical, and operational changes may be made without departing from the spirit and scope of this description and the claims. In some instances, well-known circuits, structures, or techniques have not been shown or described in detail as these are known to one skilled in the art. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

### Example Environment

The system and methods of the present disclosure can include, incorporate, or operate in conjunction with or in the environment of a database, which in some embodiments can implemented as a multi-tenant, cloud-based architecture.

Multi-tenant cloud-based architectures have been developed to improve collaboration, integration, and community-based cooperation between customer tenants without sacrificing data security. Generally speaking, multi-tenancy refers to a system where a single hardware and software platform simultaneously supports multiple user groups (also referred to as “organizations” or “tenants”) from a common data storage element (also referred to as a “multi-tenant database”). The multi-tenant design provides a number of advantages over conventional server virtualization systems. First, the multi-tenant platform operator can often make improvements to the platform based upon collective information from the entire tenant community. Additionally, because all users in the multi-tenant environment execute applications within a common processing space, it is relatively easy to grant or deny access to specific sets of data for any user within the multi-tenant platform, thereby improving collaboration and integration between applications and the data managed by the various applications. The multi-tenant architecture therefore allows convenient and cost effective sharing of similar application features between multiple sets of users.

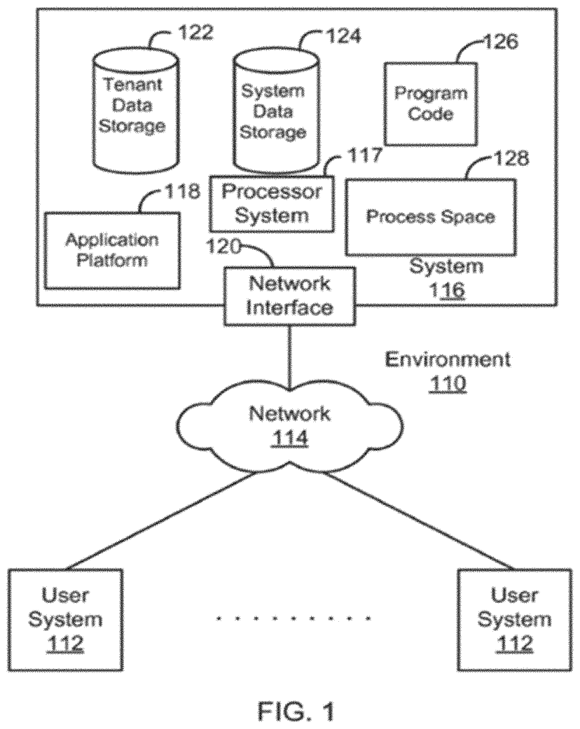

FIG. 1 illustrates a block diagram of an example environment 110 according to some embodiments. Environment 110 may include user systems 112, network 114, system 116, processor system 117, application platform 118, network interface 120, tenant data storage 122, system data storage 124, program code 126, and process space 128 for executing database system processes and tenant-specific processes, such as running applications as part of an application hosting service. In other embodiments, environment 110 may not have all of the components listed and/or may have other elements instead of, or in addition to, those listed above.

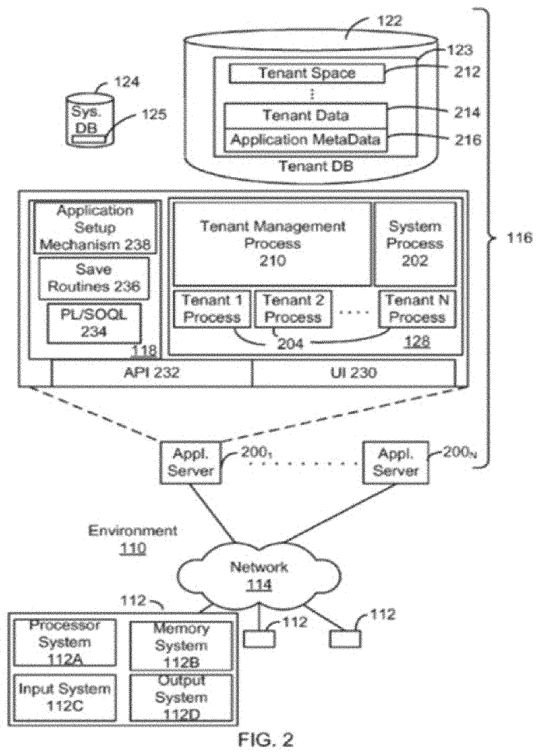

In some embodiments, the environment 110 is an environment in which an on-demand database service exists. A user system 112 may be any machine or system that is used by a user to access a database user system. For example, any of user systems 112 can be a handheld computing device, a mobile phone, a laptop computer, a notepad computer, a work station, and/or a network of computing devices. As illustrated in FIG. 1 (and in more detail in FIG. 2) user systems 112 might interact via a network 114 with an on-demand database service, which is system 116.

An on-demand database service, such as that which can be implemented using the system 116, is a service that is made available to users outside of the enterprise(s) that own, maintain or provide access to the system 116. As described above, such users do not need to necessarily be concerned with building and/or maintaining the system 116. Instead, resources provided by the system 116 may be available for such users' use when the users need services provided by the system 116—e.g., on the demand of the users. Some on-demand database services may store information from one or more tenants stored into tables of a common database image to form a multi-tenant database system (MTS). Accordingly, the “on-demand database service 116” and the “system 116” will be used interchangeably herein. The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image may include one or more database objects. A relational data base management system (RDBMS) or the equivalent may execute storage and retrieval of information against the data base object(s).

The application platform 118 may be a framework that allows the applications of system 116 to run, such as the hardware and/or software infrastructure, e.g., the operating system. In an embodiment, on-demand database service 116 may include an application platform 118 that enables creating, managing, and executing one or more applications developed by the provider of the on-demand database service, users accessing the on-demand database service via user systems 112, or third party application developers accessing the on-demand database service via user systems 112.

The users of user systems 112 may differ in their respective capacities, and the capacity of a particular user system 112 might be entirely determined by permissions (permission levels) for the current user. For example, where a salesperson is using a particular user system 112 to interact with system 116, that user system has the capacities allotted to that salesperson. However, while an administrator is using that user system 112 to interact with system 116, that user system 112 has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

The network 114 is any network or combination of networks of devices that communicate with one another. For example, the network 114 can be any one or any combination of a local area network (LAN), wide area network (WAN), telephone network, wireless network, point-to-point network, star network, token ring network, hub network, or other appropriate configuration. As the most common type of computer network in current use is a transfer control protocol and Internet protocol (TCP/IP) network, such as the global inter network of networks often referred to as the “Internet” with a capital “I” that network will be used in many of the examples herein. However, it should be understood that the networks that the present embodiments might use are not so limited, although TCP/IP is a frequently implemented protocol.

The user systems 112 might communicate with system 116 using TCP/IP and, at a higher network level, use other common Internet protocols to communicate. Such as hypertext transfer protocol (HTTP), file transfer protocol (FTP), Andrew file system (AFS), wireless application protocol (WAP), etc. In an example where HTTP is used, user system 112 might include an HTTP client commonly referred to as a “browser” for sending and receiving HTTP messages to and from an HTTP server at system 116. Such an HTTP server might be implemented as the sole network interface between system 116 and network 114, but other techniques might be used as well or instead. In some implementations, the interface between system 116 and network 114 includes load sharing functionality, such as round-robin HTTP request distributors to balance loads and distribute incoming HTTP requests evenly over a plurality of servers. At least for the users that are accessing that server, each of the plurality of servers has access to the MTS data; however, other alternative configurations may be used instead.

In some embodiments, the system 116, shown in FIG. 1, implements a web-based customer relationship management (CRM) system. For example, in one embodiment, system 116 includes application servers configured to implement and execute CRM software applications as well as provide related data, code, forms, webpages and other information to and from user systems 112 and to store to, and retrieve from, a database system related data, objects, and web page content. With a multi-tenant system, data for multiple tenants may be stored in the same physical database object. However, tenant data typically is arranged so that data of one tenant is kept logically separate from that of other tenants so that one tenant does not have access to another tenant's data, unless such data is expressly shared. In certain embodiments, the system 116 implements applications other than, or in addition to, a CRM application. For example, system 16 may provide tenant access to multiple hosted (standard and custom) applications, including a CRM application. User (or third party developer) applications, which may or may not include CRM, may be supported by the application platform 118, which manages creation, storage of the applications into one or more database objects, and executing of the applications in a virtual machine in the process space of the system 116.

One arrangement for elements of the system 116 is shown in FIG. 1, including the network interface 120, the application platform 118, the tenant data storage 122 for tenant data 123, the system data storage 124 for system data 125 accessible to system 116 and possibly multiple tenants, the program code 126 for implementing various functions of the system 116, and the process space 128 for executing MTS system processes and tenant-specific processes, such as running applications as part of an application hosting service. Additional processes that may execute on system 116 include database indexing processes.

Several elements in the system shown in FIG. 1 include conventional, well-known elements that are explained only briefly here. For example, each of the user systems 112 could include a desktop personal computer, workstation, laptop, notepad computer, PDA, cell phone, or any wireless access protocol (WAP) enabled device or any other computing device capable of interfacing directly or indirectly to the Internet or other network connection. Each of the user systems 112 typically runs an HTTP client, e.g., a browsing program, such as Microsoft's Internet Explorer browser, Netscape's Navigator browser, Opera's browser, or a WAP-enabled browser in the case of a cell phone, notepad computer, PDA or other wireless device, or the like, allowing a user (e.g., subscriber of the multi-tenant database system) of the user systems 112 to access, process, and view information, pages, and applications available to it from the system 116 over the network 114. Each of the user systems 112 also typically includes one or more user interface devices, such as a keyboard, a mouse, trackball, touch pad, touch screen, pen or the like, for interacting with a graphical user interface (GUI) provided by the browser on a display (e.g., a monitor screen, liquid crystal display (LCD) monitor, light emitting diode (LED) monitor, organic light emitting diode (OLED) monitor, etc.) in conjunction with pages, forms, applications, and other information provided by the system 116 or other systems or servers. For example, the user interface device can be used to access data and applications hosted by system 116, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each of the user systems 112 and all of its components are operator configurable using applications, such as a browser, including computer code run using a central processing unit such as an Intel Pentium® processor or the like. Similarly, system 116 (and additional instances of an MTS, where more than one is present) and all of their components might be operator configurable using application(s) including computer code to run using a central processing unit such as the processor system 117, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring the system 116 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a read only memory (ROM) or random-access memory (RAM), or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory integrated circuits (ICs)), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, virtual private network (VPN), LAN, etc.) using any communication medium and protocols (e.g., TCP/IP, HTTP, HTTPS, Ethernet, etc.) as are well known. It will also be appreciated that computer code for implementing embodiments of the present disclosure can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun MicroSystems, Inc.).

According to one embodiment, the system 116 is configured to provide webpages, forms, applications, data and media content to the user (client) systems 112 to support the access by the user systems 112 as tenants of the system 116. As such, the system 116 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., object oriented data base management system (OODBMS) or rational database management system (RDBMS)) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 2 also illustrates the environment 110, which may be used to implement embodiments described herein. FIG. 2 further illustrates elements of system 116 and various interconnections, according to some embodiments. FIG. 2 shows that each of the user systems 112 may include a processor system 112A, a memory system 112B, an input system 112C, and an output system 112D. FIG. 2 shows the network 114 and the system 116. FIG. 2 also shows that the system 116 may include the tenant data storage 122, the tenant data 123, the system data storage 124, the system data 125, a user interface (UI) 230, an application program interface (API) 232, a PL/Salesforce.com object query language (PL/SOQL) 234, save routines 236, an application setup mechanism 238, applications servers 200₁-200_{N}, a system process space 202, tenant process spaces 204, a tenant management process space 210, a tenant storage area 212, a user storage 214, and application metadata 216. In other embodiments, environment 110 may not have the same elements as those listed above and/or may have other elements instead of, or in addition to, those listed above.

The user systems 112, the network 114, the system 116, the tenant data storage 122, and the system data storage 124 were discussed above in FIG. 1. Regarding the user systems 112, the processor system 112A may be any combination of one or more processors. The memory system 112B may be any combination of one or more memory devices, short term, and/or long term memory. The input system 112C may be any combination of input devices, such as one or more keyboards, mice, trackballs, scanners, cameras, and/or interfaces to networks. The output system 112D may be any combination of output devices, such as one or more monitors, printers, and/or interfaces to networks. As shown in FIG. 2, the system 116 may include the network interface 120 (of FIG. 1) implemented as a set of HTTP application servers 200, the application platform 118, the tenant data storage 122, and the system data storage 124. Also shown is system process space 202, including individual tenant process spaces 204 and the tenant management process space 210. Each application server 200 may be configured to access tenant data storage 122 and the tenant data 123 therein, and the system data storage 124 and the system data 125 therein to serve requests of the user systems 112. The tenant data 123 might be divided into individual tenant storage areas 212, which can be either a physical arrangement and/or a logical arrangement of data. Within each tenant storage area 212, the user storage 214 and the application metadata 216 might be similarly allocated for each user. For example, a copy of a user's most recently used (MRU) items might be stored to the user storage 214. Similarly, a copy of MRU items for an entire organization that is a tenant might be stored to the tenant storage area 212. The UI 230 provides a user interface and the API 232 provides an application programmer interface to the system 116 resident processes and to users and/or developers at the user systems 112. The tenant data and the system data may be stored in various databases, such as one or more Oracle™ databases.

The application platform 118 includes an application setup mechanism 238 that supports application developers' creation and management of applications, which may be saved as metadata into tenant data storage 122 by the save routines 236 for execution by subscribers as one or more tenant process spaces 204 managed by the tenant management process 210, for example. Invocations to such applications may be coded using PL/SOQL 234 that provides a programming language style interface extension to the API 232. Some embodiments of PL/SOQL language are discussed in further detail in U.S. Pat. No. 7,730,478, filed Sep. 21, 2007, entitled, “Method and System For Allowing Access to Developed Applications Via a Multi-Tenant On-Demand Database Service,” which is incorporated herein by reference. Invocations to applications may be detected by one or more system processes, which manage retrieving the application metadata 216 for the subscriber, making the invocation and executing the metadata as an application in a virtual machine.

Each application server 200 may be communicably coupled to database systems, e.g., having access to the system data 125 and the tenant data 123, via a different network connection. For example, one application server 200₁ might be coupled via the network 114 (e.g., the Internet), another application server 200_{N-1} might be coupled via a direct network link, and another application server 200_{N} might be coupled by yet a different network connection. Transfer Control Protocol and Internet Protocol (TCP/IP) are typical protocols for communicating between application servers 200 and the database system. However, it will be apparent to one skilled in the art that other transport protocols may be used to optimize the system depending on the network connection used.

In certain embodiments, each application server 200 is configured to handle requests for any user associated with any organization that is a tenant. Because it is desirable to be able to add and remove application servers from the server pool at any time for any reason, there is preferably no server affinity for a user and/or organization to a specific application server 200. In one embodiment, therefore, an interface system implementing a load balancing function (e.g., an F5 Big-IP load balancer) is communicably coupled between the application servers 200 and the user systems 112 to distribute requests to the application servers 200. In one embodiment, the load balancer uses a least connections algorithm to route user requests to the application servers 200. Other examples of load balancing algorithms, such as round robin and observed response time, also can be used. For example, in certain embodiments, three consecutive requests from the same user could hit three different application servers 200, and three requests from different users could hit the same application server 200. In this manner, the system 116 is multi-tenant, wherein the system 116 handles storage of, and access to, different objects, data and applications across disparate users and organizations.

As an example of storage, one tenant might be a company that employs a sales force where each salesperson uses the system 116 to manage his or her sales process. Thus, a user might maintain contact data, leads data, customer follow-up data, performance data, goals and progress data, etc., all applicable to that user's personal sales process (e.g., in the tenant data storage 122). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by the system 116 that are allocated at the tenant level while other data structures might be managed at the user level. Because a MTS might support multiple tenants including possible competitors, the MTS should have security protocols that keep data, applications, and application use separate. Also, because many tenants may opt for access to a MTS rather than maintain their own system, redundancy, up-time, and backup are additional functions that may be implemented in the MTS. In addition to user-specific data and tenant specific data, the system 116 might also maintain system level data usable by multiple tenants or other data. Such system level data might include industry reports, news, postings, and the like that are sharable among tenants.

In certain embodiments, the user systems 112 (which may be client systems) communicate with the application servers 200 to request and update system-level and tenant-level data from the system 116 that may require sending one or more queries to the tenant data storage 122 and/or the system data storage 124. The system 116 (e.g., an application server 200 in the system 116) automatically generates one or more structured query language (SQL) statements (e.g., one or more SQL queries) that are designed to access the desired information. The system data storage 124 may generate query plans to access the requested data from the database.

In a database system, such as system 116 shown and described with respect to FIGS. 1 and 2, data or information may be organized or arranged in categories or groupings. Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields.

In a customer relationship management (CRM) system, for example, these categories or groupings can include various standard entities, such as account, contact, lead, opportunity, group, case, knowledge article, etc., each containing pre-defined fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants.

In some multi-tenant database systems, tenants may be allowed to create and store custom objects, or they may be allowed to customize standard entities or objects, for example by creating custom fields for standard objects, including custom index fields. Systems and methods for creating custom objects as well as customizing standard objects in a multi-tenant database system are described in further detail in U.S. Pat. No. 7,779,039, filed Apr. 2, 2004, entitled “Custom Entities and Fields in a Multi-Tenant Database System,” which is incorporated herein by reference. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Further examples of environments in which the systems and method of present disclosure may operate can be found in concurrently filed U.S. patent application with attorney docket number A4125US1/70689.39US01 entitled “Using Unstructured Input to Update Heterogeneous Data Stores,” filed on Sep. 18, 2018, and U.S. patent application with attorney docket number A4125US2/70689.41US01 entitled “Systems and Methods for Named Entity Recognition” the entirety of which is incorporated by reference herein.

A database system, such as the multi-tenant database system 116 described above, can store data or information for a wide variety of items (such as business accounts, business leads, contacts for the business accounts and leads, a contact's given name, family name, job title, employer name, street address, city, state, zip code, e-mail address, telephone number, etc.) and in a wide variety of forms (different schemas and/or data arrangements).

A database system, such as the multi-tenant database system 116 described above, may be accessed and used by a number of customers, clients, or other persons (generally, “users”), regarding some action item that the user intends to be taken with respect to updating or modifying the database system. For example, the user may intend to create a new entry (e.g., for a contact or calendar item) in the database. As another example, the user may intend to delete an existing entry (e.g., if a particular company is no longer a customer). Or, as yet another example, the user may intend to modify or update an existing entry (e.g., if the contact person for a customer has changed).

The typical user of an information database system does not know how the data is organized in the database nor its forms or schema. Thus, some provision must be made to enable, allow, or direct the user to the appropriate location (virtual or real) for the data or information item, record, object, or entry or to be modified, created, deleted, or updated. For this, it is typical to provide a user interface (UI) that presents the user with a series of forms or fields (e.g., on one or more screens, webpages, or interactive dialogues) to fill in or complete to so that the desired information or items can be accessed, retrieved, modified, updated, deleted, stored, or otherwise processed according to the intent of the user. For some users, such a fill-in-the-blank approach to interacting with an information database system is inefficient and is often frustrating.

Furthermore, in recent times, it has become increasingly more commonplace and desirable to allow human users to interact with machines, such as the database system, using language that mirrors, follows, replicates, or is similar to the way that humans interact with each other—i.e., “natural language.” Thus, when a human user is interacting with the database, it may be desirable to not restrict the user to a rigid structure, and particular words, phrases, or expressions, in order for the user to have her/his intent carried out or achieved; instead, it may be preferable to allow the user freedom to express intent in her/his own way.

### Neural Model or Intent Classifier

According to some embodiments, for a database system accessible by one or more users, such as system 116 shown and described with respect to FIGS. 1 and 2, a neural network model and related method are provided that allow a user of the database system to provide unstructured input in the form of a verbal or textual narrative or utterance that expresses the information in a language and manner that is more comfortable for the user. A portion of the narrative or utterance may relate to one or action items that the user intends to be taken with respect to the database system, such as creating, updating, modifying, or deleting a database object or record (e.g., contact, calendar item, deal, etc.). The neural model or intent classifier processes the unstructured input (narrative or utterance) and determines the intent with respect to the action item for the database. In some embodiments or in some instances, the intent classifier may present the user with its prediction or classification of the user's intent and request confirmation.

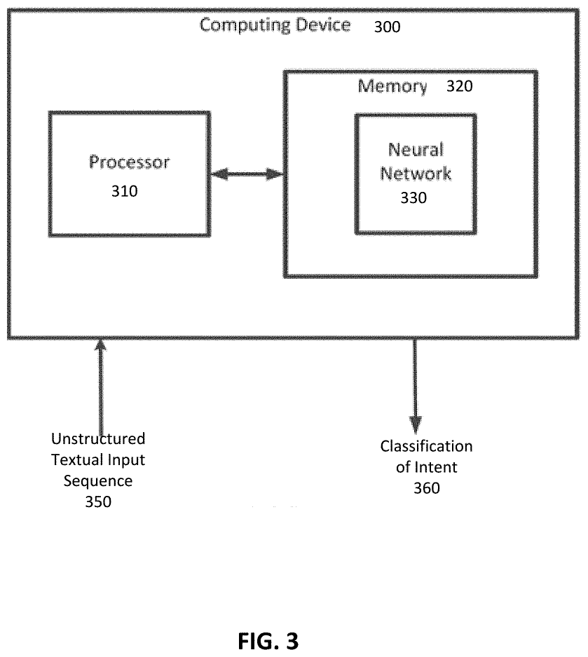

FIG. 3 is a simplified diagram of a computing device 300 according to some embodiments. As shown in FIG. 3, computing device 300 includes a processor 310 coupled to memory 320. Operation of computing device 300 is controlled by processor 310. And although computing device 100 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs), tensor processing units (TPUs), and/or the like in computing device 100. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of machine readable media. Some common forms of machine readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities. In some examples, memory 320 may include non-transitory, tangible, machine readable media that includes executable code that when run by one or more processors (e.g., processor 310) may cause the one or more processors to perform any of the methods described further herein.

As shown, memory 320 includes a neural network 330. Neural networks have demonstrated great promise as a technique for automatically analyzing real-world information with human-like accuracy. In general, neural network models receive input information and make predictions based on the input information. For example, a neural network classifier may predict a class of the input information among a predetermined set of classes. Whereas other approaches to analyzing real-world information may involve hard-coded processes, statistical analysis, and/or the like, neural networks learn to make predictions gradually, by a process of trial and error, using a machine learning process. A given neural network model may be trained using a large number of training examples, proceeding iteratively until the neural network model begins to consistently make similar inferences from the training examples that a human might make. Neural network models have been shown to outperform and/or have the potential to outperform other computing techniques in a number of applications.

Neural network 330 may be used to implement and/or emulate any of the neural networks described further herein. In some examples, neural network 330 may include a multi-layer or deep neural network. According to some embodiments, the neural network 330 may be trained with one or more encodings or datasets so that it is able to classify or determine the intent with respect to an action item for the database (e.g., update, modify, add, or delete an item, object, entry, record, etc.) based on an unstructured textual input sequence 350 from the user. In some embodiments, the neural network 330 may implement or perform natural language processing (NLP) techniques. NLP is one class of problems to which neural networks may be applied. NLP can be used to instill new neural networks with an understanding of individual words and phrases.

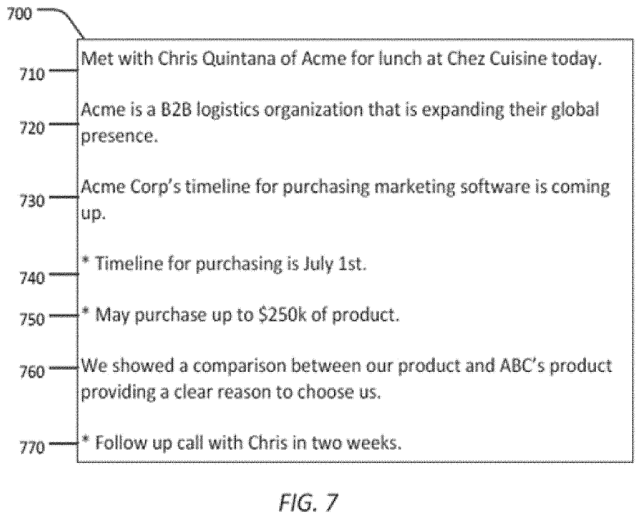

The textual input sequence 350 is unstructured data in that it can take the form of words, utterances, or phrases of the user's choosing. The textual input sequence is not constrained, restricted, or required to be in a particular form or limited to a particular set of words, phrases, or vocabulary. An example of unstructured natural language input according to some embodiments is shown in FIG. 7.

The computing device 300 can receive the unstructured textual input sequence 350 through a user interface. In some embodiments, the user interface can be implemented, incorporate, or utilize a voice to text service. Voice to text service receives diction (spoken words or utterances), live or in the form of an audio file (e.g., a MP3 file, and/or the like), and applies one or more speech recognition algorithms to the same to generate a natural language text string corresponding to the spoken words. In some examples, voice to text service may utilize one or more neural networks trained to recognize speech in audio data. In some examples, voice to text service may utilize one or more commonly available speech recognition libraries and/or APIs. In some embodiments, the user interface can be implemented as a note taking application, chatbot, or other interface through which the user writes or types the unstructured textual input sequences. A chatbot can be a service or tool (e.g., available on a website) for automated user interaction—i.e., to “chat” with the user.

At least some of the utterances, unstructured text input sequences, or natural language text strings may relate to one or more action items that are intended to be taken with respect to the database system, such as creating, updating, modifying, or deleting a database object or record (e.g., contact, calendar item, deal, etc.). Neural network 330 processes or operates on the received utterances, unstructured text input sequences, operating as a classifier to determine or classify the intent of the action item. The determinations or classifications of intent are output as results 360 from the computing device 300.

In some embodiments, neural network 330 may be used to implement an intent service. The intent service receives a natural language text string and parses the words and/or the phrases in the natural language text string to determine a desired intent of the natural language text string and/or a confidence in that determination. In some examples, the intent may be selected from a class of intents associated with desired data changes to a database and/or data store. In some examples, the class of intents may include one or more of inserting an entry (e.g., a record) in a database table, updating one or more fields of an entry (e.g., a record) in a database table, and/or the like.

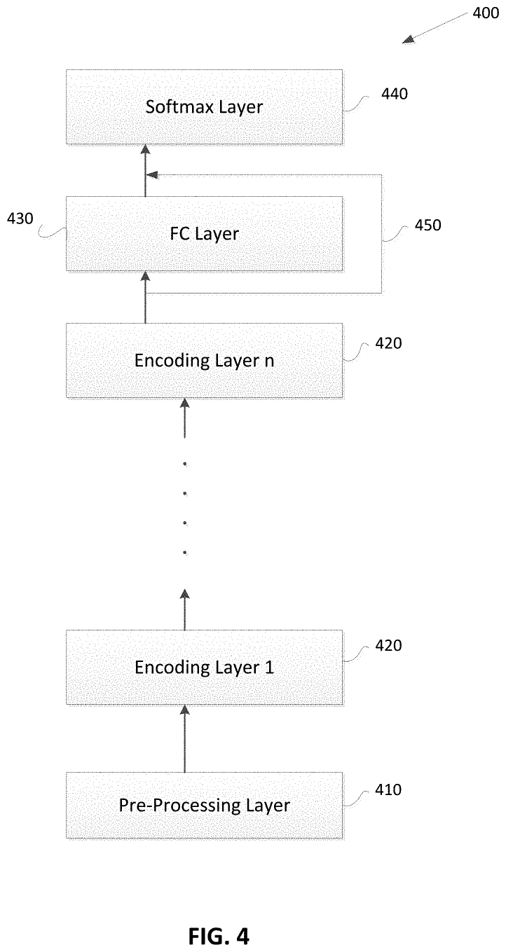

FIG. 4 is a diagram of a neural network 400 according to some embodiments.

According to some embodiments, in a database system (such as the multi-tenant database system 116 accessible by a plurality of separate and distinct organizations, shown and described with respect to FIGS. 1 and 2), the neural network model 400 allows a user of the database system to provide unstructured textual input that may relate to one or action items that the user intends to be taken with respect to the database system, and determines or makes a classification of the intent of the user with respect to the action item for the database. In some embodiments or in some instances, the intent classifier may present the user with its prediction or classification of the intent and request confirmation.

In some embodiments, as shown, neural network 400 includes a pre-processing layer 410, one or more encoding layers (lthrough n) 420, a fully connected (FC) layer 430, and a softmax layer 440.

Pre-processing layer 410 receives unstructured textual input sequences, such as narratives or utterances that may be entered by a user of a database system as described herein. At least a portion of the input sequence can relate to an action item that the user intends to be taken with respect to modifying the database system, such as creating, updating, modifying, or deleting a database object or record (e.g., contact, calendar item, deal, etc.). Each textual input sequence comprises a sequence of words. The pre-processing layer 410 generates an embedding for each word in the unstructured text input sequence. Each embedding can be a vector. In some embodiments, these can be word embeddings, such as obtained, for example, by running methods like word2vec, FastText, or GloVe, each of which defines a way of learning word vectors with useful properties. In some embodiments, the embedding may include partial word embeddings related to portions of a word. For example, the word “where” includes portions “wh,” “whe,” “her,” “ere,” and “re.” Partial word embeddings can help to enrich word vectors with subword information/FastText. In some embodiments, the embeddings may include character embeddings, e.g., from FaceBook.

Encoding layers 420 form or make up an encoder stack, which receives the embeddings from the pre-processing layer 410 and generates encodings based on the same. The encoding layers learn high-level features from the words of textual input sequence. Each encoding layer 420 generates encodings (e.g., vectors) which map the words in the text input sequence to a higher dimensional space. The encodings can encode the semantic relationship between words. In some embodiments, the encoding layers 420 or encoder stack is implemented with a recurrent neural network (RNN). RNNs are deep learning models that process vector sequences of variable length. This makes RNNs suitable for processing sequences of word vectors. In some embodiments, the encoding layers 420 can be implemented with one or more gated recurrent units (GRUs). In some embodiments, encoding layers 420 can be implemented with one or more long-term short-term memory (LSTM) encoders.

Based at least in part on the encodings from the encoding layers 420, the softmax layer 440 generates a probable classification for the intent associated with the unstructured text input sequence regarding the action item to be taken with respect to modifying the database. The classification can be, for example, one of “creating,” “updating,” or “deleting” some entry, record, object, or other item in the database system. In some embodiments, the softmax layer 440 can be implemented with a high-rank language model, called Mixture of Softmaxes (MoS), to alleviate softmax bottleneck issues.

The fully connected (FC) layer 420 deals with different combinations of features learned by the encoding layers. The FC layer 420 provides or generates weights for determining the probable classification.

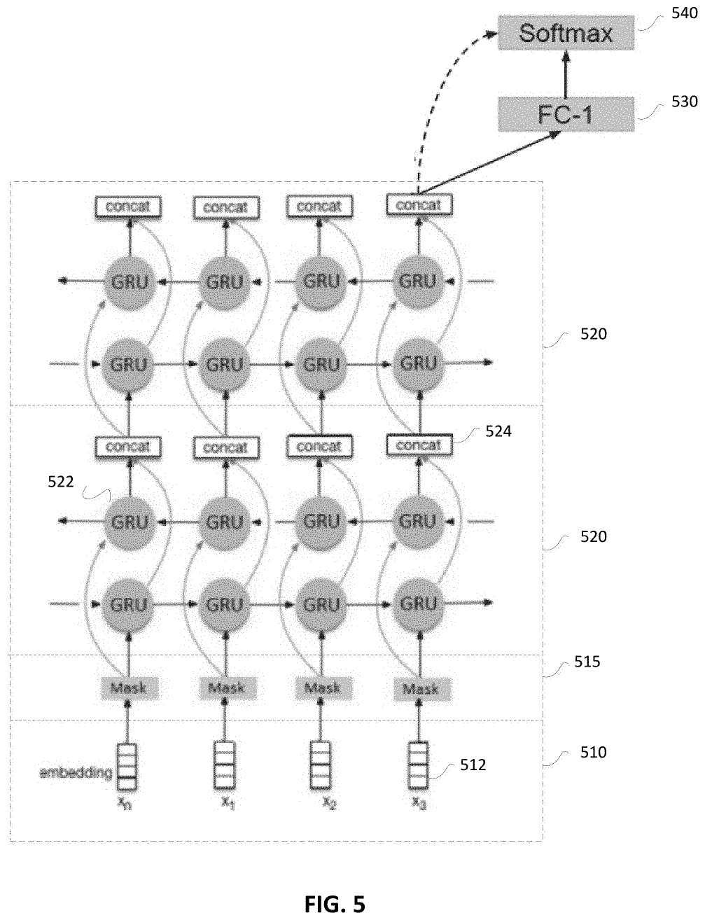

FIG. 5 is a diagram of a neural network 500 according to some embodiments. While FIG. 4 is a high-level diagram, FIG. 5 illustrates more details for the neural network, and its various layers, according to some embodiments. Neural network 500 includes a pre-processing layer 510, a mask layer 515, encoding layers 520, a fully connected (FC) layer 530, and a softmax layer 540.

According to some embodiments, neural network 500 is described in conjunction with the example of FIG. 7. FIG. 7 is a simplified diagram of an example of unstructured natural language input 700 according to some embodiments. In some examples, the natural language text may correspond to natural language text 700 of FIG. 7. As shown in FIG. 7, natural language text 700 illustrates an example of the kind of utterances or unstructured text input sequences on which the neural network 500 may operate. For ease of discussion, natural language text 700 is described with respect to each sentence in natural language text 700, which are shown with a blank line after each sentence. However, it is understood that different formats and/or groupings are possible. Further, without loss of generality, the processing of natural language text 700 is described with respect to each sentence; however other groupings such as phrases, paragraphs, utterances, and/or the like may also be used.

Sentences 740, 750, and 770 correspond to action items identified in the unstructured input, for example, by the “*” separator at the start of each action item sentence. In some embodiments, other separators, such as bullet points, can be used. Action item sentence 740 is an action item with date information “July 1st”, action item sentence 750 includes an action item with monetary information “$250k”, and action item sentence 770 includes an action item with both person information “Chris” and date information “two weeks.” In some examples, indexes (e.g., character and/or word indexes) indicating the beginning and end of each of sentences 740, 750, and 770 may also be noted for use in future processing.

Referring again to FIG. 5, as shown, in some embodiments, the pre-processing layer 510 generates one or more embeddings 512, each of which relates to a corresponding word in the unstructured text input sequence. Thus, for sentence 740 shown in FIG. 7, pre-processing layer 510 would generate embedding 512 for each of the words “Timeline,” “for,” “purchasing,” “is,” “July,” and “1st.” In some instances, a text input sequence, e.g., used for training, may comprise few words, in which case, the embeddings output from pre-processing layer 510 can be “padded,” e.g., with zeros. The mask layer 515 masks such numbers so that they are ignored or not processed in subsequent layers, for example, to help reduce training time.

In some embodiments, as shown, each encoding layer 520 is implemented with or includes a plurality of gate recurrent units (GRUs) 522. A GRU is a specific model of recurrent neural network (RNN) that intends to use connections through a sequence of nodes to perform machine learning of tasks associated with memory and clustering, for example, in speech recognition. GRUs help to adjust the neural network input weights to solve the vanishing gradient problem that is common issue with RNNs.

The GRUs 522 may be arranged in rows. A first row of GRUs 522 looks at or operates on information (e.g., embeddings or encodings) for respective words in the unstructured text input sequence in a first (e.g., “forward”) direction, with each GRU 522 generating a corresponding hidden state vector and passing that vector along to the next GRU in the row (e.g., as indicated by the arrows pointing from left to right). For example, with respect to the example of text sequence 740 shown in FIG. 7, the first row of GRUs 522 would operate on the embeddings for each of the words in the order of “Timeline,” “for,” “purchasing,” “is,” “July,” and “1st.” A second row of GRUs 522 looks at or operates on information (e.g., embeddings or encodings) for respective words in the input sequence in a second (e.g., “backward”) direction, with each GRU 522 generating a corresponding hidden state vector and passing that vector along to the next GRU in the row (e.g., as indicated by the arrows pointing from right to left). For example, with respect to the example of text sequence 740 shown in FIG. 7, the second row of GRUs 522 would operate on the embeddings for each of the words in the order of “1st,” “July,” “is,” “purchasing,” “for,” and “Timeline.” The hidden state vectors corresponding to each word are concatenated at a respective concatenator 524.

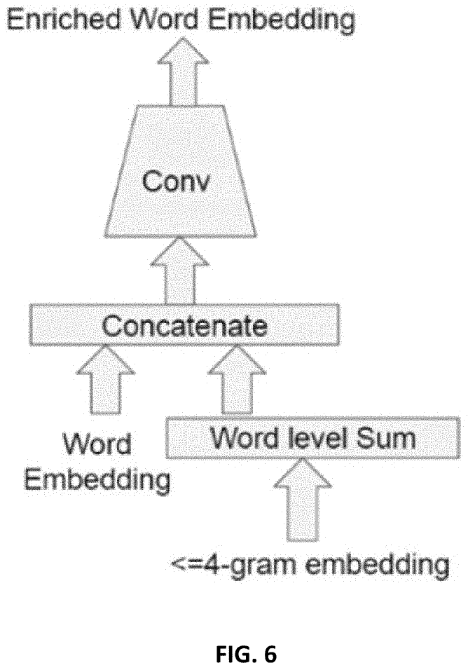

FIG. 6 is a diagram of a portion of a pre-processing layer 600 of a neural network according to some embodiments. This portion of the processing layer operates on one word, or portions of a word, from the utterance or unstructured text input sequence. A word embedding is generated for the word, and a partial word embedding is created for each portion of a word.

The partial word embeddings may be referred to as “n-gram” embeddings, where n is the maximum number of characters in the word that are considered. Thus, using the word “where” as an example, and n=3, it will be represented by the character n-grams: <wh, whe, her, ere, and re>. The goal of partial word embeddings is to independently predict the presence (or absence) of context words. In some embodiments, for the word at position t in an unstructured text sequence, all context words are considered as positive examples, and negatives are sampled at random from a dictionary. For a chosen context position c, using the binary logistic loss, the following negative log-likelihood can be obtained:

$$log ( 1 + {e}^{- \text{?}} ) + log ( 1 + {e}^{\text{?}} )$$

$$\text{?} \text{indicates text missing or illegible when filed}$$

where N_{t,c} is a set of negative examples sampled from the vocabulary. Partial word embeddings allow the neural network to address or handle out-of-vocabulary words—such as, for example, proper names (e.g., “Benioff”), organizational names, misspellings (e.g., “Heelllloooo,”), etc.—which might not otherwise appear in a list of pretrained word embeddings.

Referring again to FIG. 6, the word embedding and partial word embeddings are concatenated and provided as enriched word embeddings to the encoding layers of the neural network.

### Training

While the systems and methods, including the neural network (e.g., 330, 400, 500), of the present disclosure operate to determine or classify the intent of action items to the database system based on the utterances or unstructured text input sequences, it is not necessarily the case that all determinations or classifications will be correct. How the intent classifier or neural network performs will depend at least in part on how it is trained.

According to some embodiments, the layers of the neural network are pretrained on a large corpus of training data—including multiple training data sets, such as Wikipedia—so that the model is pretrained to understand the language; this drastically reduces the number of examples needed to train for a custom intent model.

In some embodiments, the various organizations or entities using the database can submit training data sets to train the model for a wide variety of intent, and classification thereof. As such, in some embodiments, the model architecture, the choice of model parameters, and training scheme for the intent classifier or neural network are configured or changed based on or taking into consideration the following: the size of the training data set (e.g., the number of examples or utterances in a training data set, the length or number of words in each example or utterance, and the number of classes for which intent is to be determined (e.g., create, update, or delete). This helps or allows the intent classifier service to work well for a wide variety of cases.

Thus, for example, in some embodiments, the fully connected (FC) layer (e.g., 430 or 530) is not utilized or employed for all training data sets. Instead, it can be used for small training data sets (e.g., 150 or less utterances or input word sequences). The FC layer may determine which features in a particular training data set correlate to a particular classification for the intent associated with the unstructured text sequence. For large training data sets (e.g., more than 150 utterances or input word sequences), where use of the FC layer could consume significantly more computing resources, the FC layer can be bypassed, for example, using a bypass (e.g., 450).

In some embodiments, the intent classifier or neural network can be global or generic for all users of the database system. With a multi-tenant database system 116 accessible by users from a plurality of separate and distinct organizations, shown and described with respect to FIGS. 1 and 2, the neural model may receive and process a wide variety of unstructured text input sequences or utterances. This is because different entities, organizations, industries, etc. may have their own specialized vocabulary, jargon, acronyms, code words, etc., or because some users may (intentionally or unintentionally) input out-of-topic utterances or sequences that are not necessarily relevant to interaction with the database system.

So that the neural network 400 can better learn how to handle and make classifications for the disparate users, entities, organizations, industries, etc. using the database, it can be trained on a plurality of data sets. These data sets can include, for example, records of various interactions (e.g., “chats” or other text, audio recordings) made by users from one or multiple organizations or entities in connection with accessing or using the database system. These data sets can vary in size. For example, multi-tenant database system 116 might be used by many organizations or entities in the accounting industry, and thus a data set for this industry may include a large or substantial number of utterances for training. In contrast, the multi-tenant database system may be used by far fewer organizations or entities in, for example, the exotic fish aquarium industry, and thus the training data set of utterances for such industry may relatively small.

According to some embodiments, in instances where there may be a significant number of utterances or input text sequences that the neural model is not readily able to make a determination or classification of intent (e.g., for an organization or entity in a relatively unique or obscure industry, or one that uses its own specialized or unique jargon, acronyms, code words, vocabulary, etc.), provision can be made for a process to identify or classify examples of the utterances or text sequences manually. That is, the computer system (e.g., computing device 300) can publish, present, or otherwise provide examples of utterances or text sequences to such entity or organization. In some embodiments, it may be preferable to use select examples with low probability of the neural network predicting or determining the intent on its own. These can be utterances or text sequences that are particularly heavy on specialized vocabulary, unique to an entity or organization, or perhaps even a particular user. A human, such as a user or product manager associated with the entity/organization, labels or classifies the examples (e.g., indicating that an example text sequence relates to creating a new contact entry in the database). After that, the labeled or classified example utterances or text sequences can be provided or fed into the neural network for use in training and learning so that it will be more able to determine or classify other utterances or text sequences going forward.

Similarly, according to some embodiments, training of the neural network model may also include training for utterances or unstructured text input sequences that are adversarial or otherwise out of topic with respect to interaction with the database. In particular, it is possible that some users may, intentionally or unintentionally, input utterances or text sequences that do not relate to action items intended for the database. For example, a user might say or type, “What is your name?” or “I'm hungry.” Or a user that is experiencing frustration might enter, “You are so stupid.” Such arbitrary out-of-topic utterances or text sequences can fall outside of the typical examples on which the neural network is trained, and thus, the neural network might not be prepared or equipped to handle these kinds of unstructured input sequences. The neural network could make an incorrect classification, thus potentially could causing a user to become even more frustrated. To address this, in some embodiments, the neural network is provided with training data that includes generic out-distribution samples. And the neural network is provided with augmented classifiers—e.g., “I don't understand”—which can be output in response. This can provide or lead to a better or more optimal experience for users.

### Confidence Threshold

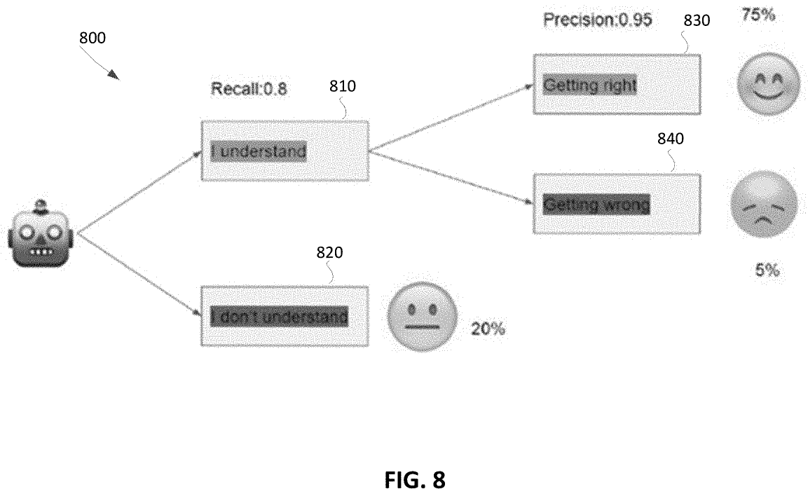

FIG. 8 illustrates a decision flow 800 for presenting a user with a determination or classification of intent based on confidence level according to some embodiments.

Referring to FIG. 8, for any given utterance or unstructured text sequence input into the intent classifier or neural network, there is a possibility that the neural network will not be able to make a determination or classification as to the intent of a related action item, and it may need to ask or query the user for more or different information (e.g., “I don't understand,” at 820).

Even when the neural network is able to make a determination or classification, there is a possibility that the determination is wrong. The probability that the determination or classification is correct can be viewed as the level of “confidence” in that result. In the situation where there is some possibility that the determination or classification is wrong (i.e., less than 100% confidence), a choice can be made as to whether the determination/classification should still presented or returned to the user (e.g., “I understand,” at 810) or whether to the query the user for more information (e.g., “I don't understand,” at 820). The probability or percentage of presenting the user with a determination or classification of intent—even if there is a chance that it is wrong—can be viewed as “recall.”

When presented with the determination or classification, the user is able to see whether the determined or classified intent is correct (at 830) or incorrect (at 840). The probability that the user is presented with a determination or classification that is correct may be viewed as the perceived “precision” of the intent classifier or neural network. As a corollary, the false discovery rate (FDR) of the classifier or network is the probability that presented determination/classification is incorrect: Precision=1−FDR.

While the intent classifier or neural network can be global or generic for all users of the database system (such as multi-tenant database system 116 accessible by a plurality of separate and distinct organizations or entities), not all users may require or need the same level of precision. For example, some organizations may want a very high level of precision (e.g., over 95%), whereas other organizations would be satisfied with a lower level of precision (e.g., 80%).

As a general matter, the precision of the intent classifier or neural network will increase with more training or exposure to more training data sets. In some embodiments, a framework is provided by which an organization or entity can determine, control, or configure the training of the intent classifier or neural model so that it returns determinations or classifications of intent at the level of precision desired by or acceptable to that organization or entity.

According to some embodiments, additional data for training can be obtained by configuring whether or not to present a determination or classification depending on its confidence level. If the confidence level is high (indicating a greater probability that the determination/classification is correct), the system will present the determination or classification to the user. On the other hand, if the confidence level is low (indicating a greater probability that the determination/classification is incorrect), the system may query the user for more information (e.g., “I don't understand,” or “Pardon me, please say differently), basically, asking the user to try again. Any information received from the user is then fed back into the neural network for processing and training.

For organizations or entities desiring higher precision (or lower FDR), the threshold confidence level at which a determination or classification is presented to a user can be set relatively high. For any determination/classification falling below this threshold, the system will query or prompt the user for more information. While there is a greater chance that any determinations or classifications presented to the users will be correct, there may be a greater likelihood that the users are asked to retry. (The opposite will be true if the threshold confidence level is set relatively low.) But with each retry, the neural network is provided with more diverse training data (in the form of alternate examples of utterances or text sequences) from which it can learn.

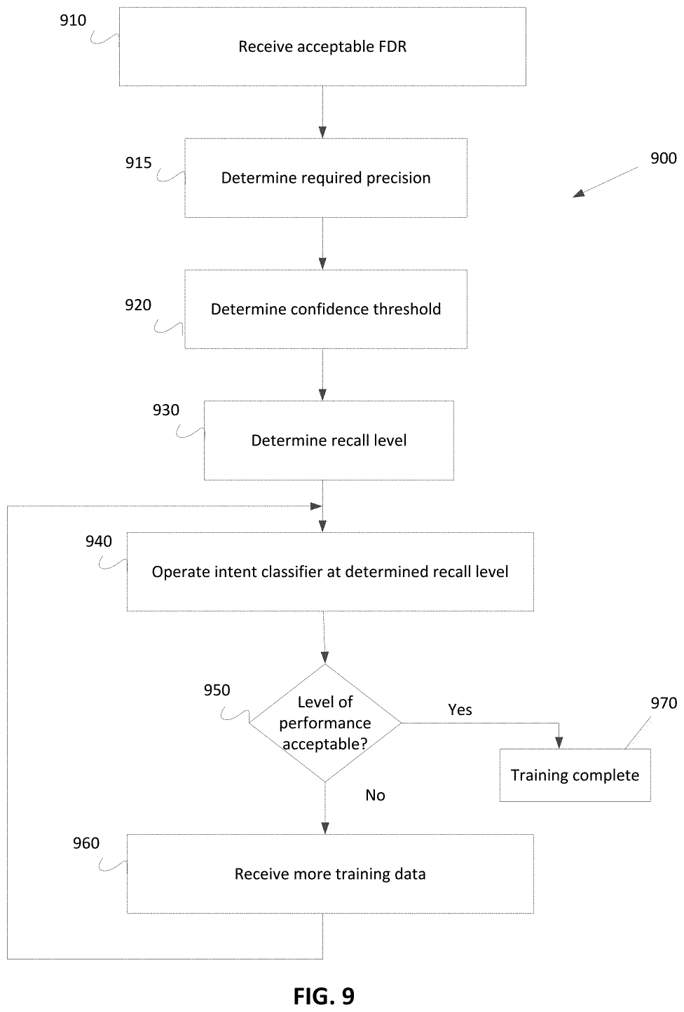

FIG. 9 is a flowchart of a method 900 for configuring or setting the training of an intent classifier or neural network according to some embodiments. Method 900 allows an organization or entity (e.g., product owner or manager) to control or set training so that the classifier or network outputs determinations or classifications of intent at a level of precision that is acceptable to the organization or entity, and can provide for training on more or less additional data sets. In some embodiments, method 900 may be performed by a computing device (e.g., 100), either separate from or implementing the intent classifier or neural network.

At a process 910, the computing device receives, e.g., from an organization or entity, an acceptable false discovery rate (FDR), which is the tolerance (fraction of predictions) of the intent model to predict or classify something wrong. Above such tolerance, users of the database system from that organization or entity might get frustrated.

At a process 915, the computing device determines a required level of precision for the determinations or classifications of intent returned by the classifier or neural network:Precision=1−FDR.

As explained above, the actual precision of the classifier or neural network is a function of the recall level and confidence threshold at which determinations or classifications of intent are presented to a user. In other words, precision, recall, and confidence threshold are related. At a process 920, using the required precision of the system to look up against the computed Precision-Recall (PR) curve, the computing device determine the corresponding confidence threshold (this threshold is used against the probability returned for each prediction by the intent model). In some embodiments, the computing device calculates, derives, or determines an appropriate confidence threshold, for example, by consulting or referencing a precision-recall (PR) curve and bilinear/bicubic intrapolation. Any predictions of the intent classifier or neural network model below this confidence threshold are not accepted; any predictions of intent above the confidence threshold are accepted.

At a process 930, the computing device calculates, derives, or determines a corresponding (best possible) recall level. In some embodiments, this can be accomplished using the PR curve and determined confidence threshold.

At a process 940, the intent classifier or neural network is then operated, with its determinations or classifications presented to users at the determined recall level. When operating the classifier or neural network, the concept of user perceived recall is used. Perceived recall relates to the number of times that the user is required or requested to provide alternative utterance for conveying the intent using natural language until the neural model generates or determines the right intent. In some embodiments, this number of tries can be set, configured, or decided by the entity or organization (e.g., product owner or manager).

At a process 950, the computing device determines whether operation of the classifier or neural network at the perceived recall level is acceptable to the entity or organization. If not, at a process 960, the computing device receives more training data with diverse examples. This may be accomplished, for example, by prompting or querying users for alternate utterance or text sequences. The processes are repeated until the intent classifier or neural network reaches an acceptable level of performance. Then, at process 970, training is complete.

Some examples of computing devices, such as computing device 300 may include non-transitory, tangible, machine readable media that include executable code that when run by one or more processors (e.g., processor 310) may cause the one or more processors to perform the processes of methods 800 and 900. Some common forms of machine readable media that may include the processes of methods 800 and 900 are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

The confidence threshold scheme for configuring or setting training of the neural network works well if it is used in conjunction with multiple tries by users (i.e., different utterances or text sequences related to the same action item intended for the database). Tests and studies have shown that the false discovery rate (FDR) reduces exponentially with a higher number of tries, as seen for example, in the table shown below:

| | % of time not understanding the | |
|---|---|---|
| # of tries | intent | Effective Recall |
| 1 | 20% | 0.8 |
| 2 | 4% | 0.96 |
| 3 | 0.8% | 0.992 |

Although illustrative embodiments have been shown and described, a wide range of modifications, changes and substitutions are contemplated in the foregoing disclosure and in some instances, some features of the embodiments may be employed without a corresponding use of other features. One of ordinary skill in the art would recognize many variations, alternatives, and modifications. Thus, the scope of the present application should be limited only by the following claims, and it is appropriate that the claims be construed broadly and in a manner consistent with the scope of the embodiments disclosed herein.

What is claimed is:

1. A neural network for determining an intent associated with an unstructured text input sequence, the neural network comprising:
a pre-processing layer configured to receive the unstructured text input sequence, wherein the unstructured text input sequence comprises a plurality of words, wherein at least a portion of the unstructured text input sequence relates to an action item to be taken with respect to modifying a database, the pre-processing layer configured to generate an embedding for each word in the unstructured text input sequence;
an encoder stack comprising a plurality of encoding layers, each of the encoding layers configured to generate encodings for the embeddings;
a softmax layer configured to generate, based at least in part on the encodings, a probable classification for the intent associated with the unstructured text input sequence regarding an action item to be taken with respect to modifying the database;
a fully connected layer configured to provide weights for determining the probable classification; and
a bypass path;
wherein the neural network is operable to be trained on a plurality of training data sets, the fully connected layer is configured to determine which features in a given training data set correlate to a particular classification, and the bypass path is configured to bypass the fully connected layer for some training data sets.

2. The neural network of claim 1, wherein the neural network performs a natural language processing task.

3. The neural network of claim 1, wherein the action item comprises one of updating, modifying, adding, or deleting an item of the database.

4. The neural network of claim 1, wherein each encoding layer comprises a plurality of gated recurrent units, each gated recurrent unit configured to generate a vector related to at least one word in the unstructured text input sequence.

5. The neural network of claim 1, wherein each encoding layer comprises:
a first row of gated recurrent units configured to serially process the words in the unstructured text input sequence in a first direction to generate respective first vectors;
a second row of gated recurrent units configured to serially process the words in the unstructured text input sequence in a second direction to generate respective second vectors; and
a concatenating layer configured to concatenate the first and second vectors.

6. The neural network of claim 1, wherein the embedding for each word comprises a word embedding.

7. The neural network of claim 1, wherein the embedding for each word comprises a partial word embedding.

8. The neural network of claim 1, wherein the database comprises a multi-tenant database accessible by a plurality of separate organizations.

9. The neural network of claim 8, wherein training of the neural network is capable of being individually configured by at least some of the separate organizations.

10. A method for determining an intent associated with an unstructured text input sequence, the method performed by a neural network and comprising:
receiving, by a pre-processing layer, the unstructured text input sequence, wherein the unstructured text input sequence comprises a plurality of words, wherein at least a portion of the unstructured text input sequence relates to an action item to be taken with respect to modifying a database, the pre-processing layer configured to generate an embedding for each word in the unstructured text input sequence;
generating, by an encoder stack comprising a plurality of encoding layers, encodings for the embeddings;
based at least in part on the encodings, generating, by a softmax layer, a probable classification for the intent associated with the unstructured text input sequence regarding an action item to be taken with respect to modifying the database;
providing, by a fully connected layer, weights for determining the probable classification;
wherein the neural network is operable to be trained on a plurality of training data sets;
determining, by the fully connected layer, which features in a given training data set correlate to a particular classification; and
bypassing the fully connected layer for some training data sets.

11. The method of claim 10, comprising performing a natural language processing task.

12. The method of claim 10, wherein the action item comprises one of updating, modifying, adding, or deleting an item of the database.

13. The method of claim 10, wherein generating encodings for the embeddings comprises generating a vector related to at least one word in the unstructured text input sequence.

14. The method of claim 10, wherein generating encodings for the embeddings comprises:
serially processing the words in the unstructured text input sequence in a first direction to generate respective first vectors;
serially processing the words in the unstructured text input sequence in a second direction to generate respective second vectors; and
concatenating the first and second vectors.

15. The method of claim 10, wherein the embedding for each word comprises a word embedding.

16. The method of claim 10, wherein the embedding for each word comprises a partial word embedding.

17. The method of claim 10, wherein the database comprises a multi-tenant database accessible by a plurality of separate organizations.

18. The method of claim 17, wherein training of the neural network is capable of being individually configured by at least some of the separate organizations.
